(19) United States
(12) Patent Application Publication
(10) Pub. No.: US 2025/0327976 A1
(43) Pub. Date: Oct. 23, 2025

(54) HYBRID FIBER AND ELECTRICAL CONNECTOR WITH CONDUCTOR AND PROTECTOR

(71) Applicant: Panduit Corp., Tinley Park, IL (US)

(72) Inventors: Yu Huang, Orland Park, IL (US); Masud Bolouri-Saransar, Orland Park, IL (US); Ryan N. Murphy, Monee, IL (US); Jose M. Castro, Naperville, IL (US); Thomas M. Sedor, Orland Park, IL (US); Frank J. Dundek, New Lenox, IL (US); Satish I. Patel, Roselle, IL (US)

(73) Assignee: Panduit Corp., Tinley Park, IL (US)

(21) Appl. No.: 19/077,699

(22) Filed: Mar. 12, 2025

Related U.S. Application Data
(60) Provisional application No. 63/635,061, filed on Apr. 17, 2024.

(51) Int. Cl. G02B 6/38

(52) U.S. Cl. CPC G02B 6/3817; G02B 6/3825; G02B 6/3831; G02B 6/3893

(57) ABSTRACT

A hybrid fiber optic connector and adapter assembly is provided as a solution for providing both optical fiber and electrical wire together to transmit both data and power delivery within the same form factor as existing connector and adapter assemblies.

### CROSS-REFERENCE TO RELATED APPLICATION(S)

This application claims benefit to U.S. Provisional Patent Application No. 63/635,061, filed on Apr. 17, 2024, the entirety of which is hereby incorporated by reference herein.

### TECHNICAL FIELD

The application relates to a hybrid optical and electrical connector assembly based on the existing connector system. It utilizes conductor parts that are attached to the existing connector parts. It provides the benefits of hybrid data and power delivery by giving power and fiber optic connectivity to intermedia and end devices in equipment rooms, zones, and work areas, with low cost, simple field termination, and reliable optical communications.

### BACKGROUND

Conventional connectors often specialize in either electrical power transmission or optical data communication, necessitating the use of multiple connectors and cables to cater to diverse functionalities in various applications. The demand for streamlined and versatile connector solutions has steadily increased in numerous industries and application scenarios.

### SUMMARY

Disclosed herein are exemplary new hybrid connector and adapter systems that are configured to provide a solution for misaligning proper polarity when connecting hybrid cables together using connector and adapter assemblies.

A hybrid cable connector is disclosed, the hybrid cable connector comprising a duplex connector housing including a first connector housing and a second connector housing; a first pair of conductive plates attached to a bottom floor of the first connector housing; a second pair of conductive plates attached to a bottom floor of the second connector housing; and a push-pull clip including holder slot configured to hold an insulative protector to cover over at least a portion of the bottom floor of the first connector housing and at least a portion of the bottom floor of the second connector housing

A hybrid cable adapter is disclosed, the adapter comprising a first side housing and a second side housing, the first side housing including a first pair of openings for installing a first duplex connector and the second side housing including a second pair of openings for installing a second duplex connector; a plurality of leaf springs, wherein a first end of the plurality of leaf springs are configured to contact a first set of conductive plates attached to the first duplex connector, and wherein a second end of the plurality of leaf springs are configured to contact a second set of conductive plates attached to the second duplex connector; and a fiber transmission tunnel configured to transmit an optical fiber from the first duplex connector installed into the first side housing to the second duplex connector installed into the second side housing.

A hybrid cable connector is disclosed, the hybrid cable connector comprising a fiber connector comprising a top surface including a latch, a bottom surface, and an internal housing configured to house a fiber component, a pair of conductive plates attached to the bottom surface of the fiber connector, an insulative protector configured to cover at least a portion of the bottom surface where the pair of conductive plates are attached, and a push-pull clip comprising an opening for holding the fiber connector.

A hybrid cable adapter is disclosed, the adapter comprising a first side housing comprising a first opening for installing a first hybrid connector and a first pair of slot channels, a second side housing comprising a second opening for installing a second hybrid connector and a second pair of slot channels, a pair of leaf springs including a first portion configured to be housed within the first pair of slot channels and a second portion configured to be housed within the second pair of slot channels, wherein the first portion is configured to contact a first set of conductive plates attached to the first hybrid connector, and wherein the second portion is configured to contact a second set of conductive plates attached to the second hybrid connector, and a fiber transmission tunnel configured to transmit an optical fiber from the first hybrid connector installed into the first side housing to the second hybrid connector installed into the second side housing.

A detailed description of these and other non-limiting exemplary embodiments of the hybrid cable assemblies is set forth below together with accompanying drawings.

### BRIEF DESCRIPTION OF THE DRAWINGS

FIG. 1 shows a perspective view of an exemplary fiber optic connector.

FIG. 2 shows a top-down view of an exemplary shuttered fiber optic connector adapter.

FIG. 3A shows a perspective view of an exemplary duplex hybrid fiber connector, according to an embodiment of the present disclosure.

FIG. 3B shows a top-down view of the duplex hybrid fiber connector shown in FIG. 3A, according to an embodiment of the present disclosure.

FIG. 3C shows an exploded perspective view of the duplex hybrid fiber connector shown in FIG. 3A, according to an embodiment of the present disclosure.

FIG. 4A shows a perspective view of a first connector including a safety protector feature included in the duplex hybrid fiber connector shown in FIG. 3, according to an embodiment of the present disclosure.

FIG. 4B shows a perspective view of a second connector including a safety protector feature included in the duplex hybrid fiber connector shown in FIG. 3, according to an embodiment of the present disclosure.

FIG. 5A shows a front-side view of the first connector shown in FIG. 4A, according to an embodiment of the present disclosure.

FIG. 5B shows a front-side view of the second connector shown in FIG. 4B, according to an embodiment of the present disclosure.

FIG. 6 shows a perspective view of a conductive plate included in the duplex hybrid fiber connector shown in FIG. 3A, according to an embodiment of the present disclosure.

FIG. 7A shows a perspective view of a hybrid duplex adapter for receiving the duplex hybrid fiber connector shown in FIG. 3A, according to an embodiment of the present disclosure.

FIG. 7B shows a top-down view of the hybrid duplex adapter shown in FIG. 7A, according to an embodiment of the present disclosure.

FIG. 7C shows an exploded perspective view of the hybrid duplex adapter shown in FIG. 7A, according to an embodiment of the present disclosure.

FIG. 8A shows a front-side view of an adapter half included in the hybrid duplex adapter shown in FIG. 7A, according to an embodiment of the present disclosure.

FIG. 8B shows a cross-sectional view of the adapter half shown in FIG. 8A taken along the line 8B-8B, according to an embodiment of the present disclosure.

FIG. 9A shows a perspective view of the duplex hybrid fiber connector and the hybrid duplex adapter prior to an installation, according to an embodiment of the present disclosure.

FIG. 9B shows a perspective view of the duplex hybrid fiber connector installed into both sides of the hybrid duplex adapter in an installed state, according to an embodiment of the present disclosure.

FIG. 10 a top-down view of the duplex hybrid fiber connector installed into both sides of the hybrid duplex adapter in the installed state, according to an embodiment of the present disclosure.

FIG. 11 shows a perspective view of a duplex hybrid fiber connector including an alternative push-pull clip and sliding protector, according to an alternative embodiment of the present disclosure.

FIG. 12A shows a top-down view of the duplex hybrid fiber connector shown in FIG. 11, according to the alternative embodiment of the present disclosure.

FIG. 12B shows a front-side view of the duplex hybrid fiber connector shown in FIG. 11, according to the alternative embodiment of the present disclosure.

FIG. 13 shows an exploded perspective view of the duplex hybrid fiber connector shown in FIG. 11, according to the alternative embodiment of the present disclosure.

FIG. 14 shows a perspective view of the alternative push-pull clip and sliding protector shown in FIG. 11, according to the alternative embodiment of the present disclosure.

FIG. 15A shows a side view of the duplex hybrid fiber connector shown in FIG. 11 prior to an installation into the hybrid duplex adapter, according to the alternative embodiment of the present disclosure.

FIG. 15B shows a side view of the duplex hybrid fiber connector shown in FIG. 11 installed into both sides of the hybrid duplex adapter in an installed state, according to the alternative embodiment of the present disclosure.

### DETAILED DESCRIPTION

As required, detailed non-limiting embodiments are disclosed herein. However, it is to be understood that the disclosed embodiments are merely exemplary and may take various and alternative forms. The figures are not necessarily to scale, and features may be exaggerated or minimized to show details of particular components. Therefore, specific structural and functional details disclosed herein are not to be interpreted as limiting, but merely as a representative basis for teaching one skilled in the art.

Recognizing the evolving needs for both fast data transmission and power delivery at remote locations, the hybrid connector emerges as a pioneering solution, adeptly surmounting the limitations of traditional connectors. This innovative hybrid connector seamlessly integrates the capabilities of transmitting electric power and optical data over a unified connector interface. This amalgamation of power delivery and data communication within a single hybrid connector presents many compelling advantages.

First and foremost, it substantially reduces installation costs, preventing the requirement for multiple connectors, intricate cabling, and the associated installation complexities. Moreover, it simplifies the infrastructure, leading to tidier and more efficient cable management. The versatility it brings to system design is another boon, granting engineers and designers enhanced flexibility to tailor systems to specific needs and constraints. The applicability of such a connector extends to a wide array of sectors, particularly in scenarios where electrical power delivery and high-speed data communication are indispensable. These encompass but are not limited to cutting-edge domains like smart grid systems, industrial automation, data centers, and telecommunications networks.

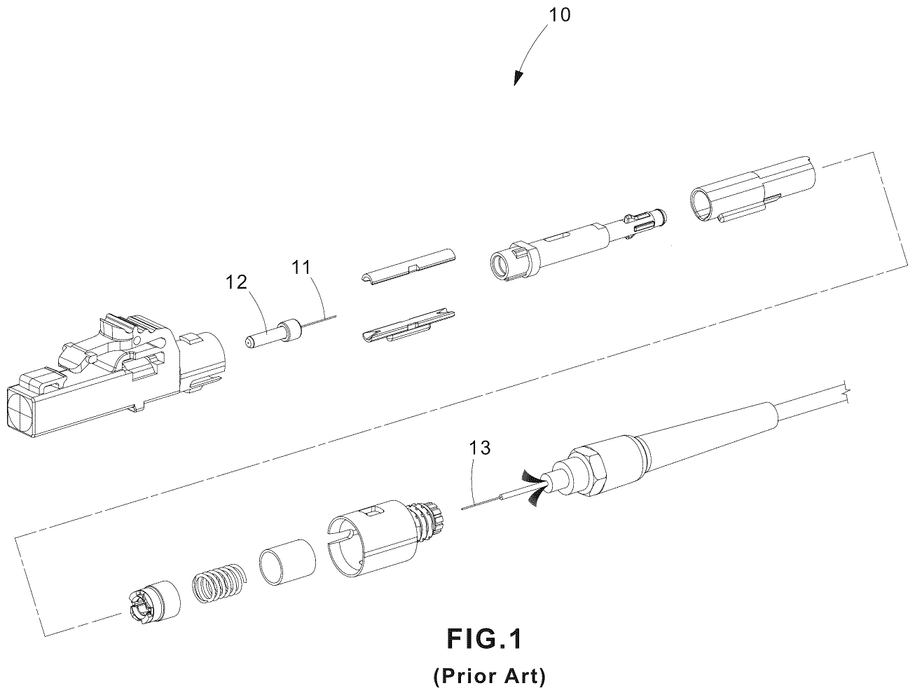

Hybrid connectors that enable the coexistence of optical fiber and electrical conductors have been developed. However, previous hybrid connectors are bulky and complicated to manufacture. Therefore, it is desirable to develop a compact hybrid connector with the size and footprint of the standard fiber optic connector (e.g., LC connector type or SC connector type). Moreover, such hybrid fiber and electrical connectors could further be field terminated like the OptiCam fiber connector from Panduit Corp. described in U.S. Pat. Nos. 7,011,454 and 8,256,970, the entirety of both of which are hereby incorporated by reference herein, to bring convenience and more installation flexibility, as shown by the field terminable fiber optic connector 10 in FIG. 1. The field terminable fiber optic connector 10 features a stub fiber 11 with one pre-polished end 12, allowing for rapid assembly with a field fiber 13, resulting in the swift creation of the field terminable fiber optic connector 10.

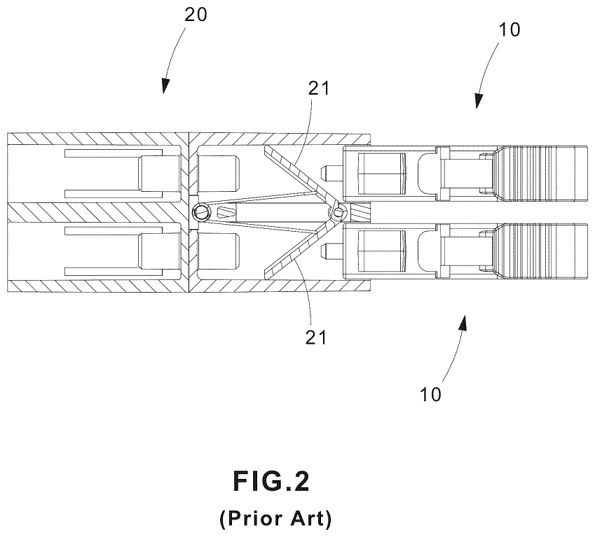

Additionally, an adapter 20 for hybrid fiber and electrical connectors should incorporate shutters 21, as shown in FIG. 2, designed to serve a dual purpose: preventing the ingress of dust and debris while safeguarding the eyes of workers or technicians involved in installing or maintaining a fiber optic system. This protective function shields them from potential harm caused by the light emitted from uncovered connectors, a concept outlined in U.S. Pat. No. 9,709,754 assigned to Panduit Corp., the entirety of which is hereby incorporated by reference herein.

The disclosed solution is a method and hybrid cable connector and adapter assembly system configured to attach a power transmission system to an existing LC fiber optic connector and adapter system. This solution utilizes an existing form factor of an LC fiber optic connector housing that has been modified, but other versions of this invention could be applied to completely unmodified LC connector housings. This solution describes utilizing the LC connector system. Still, it can be applied to many duplex connectors, such as SC, CS, and SN, or even parallel fiber optic connectors, such as MTP/MPO. It is fully field-terminable and can incorporate shutters.

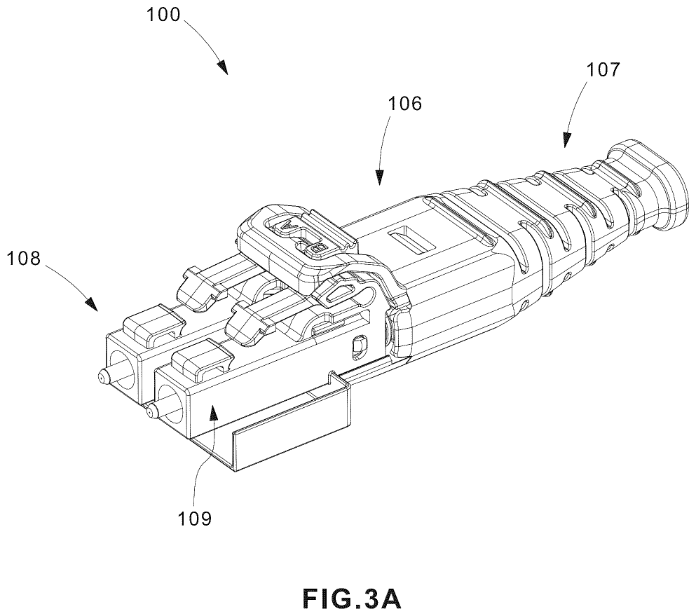

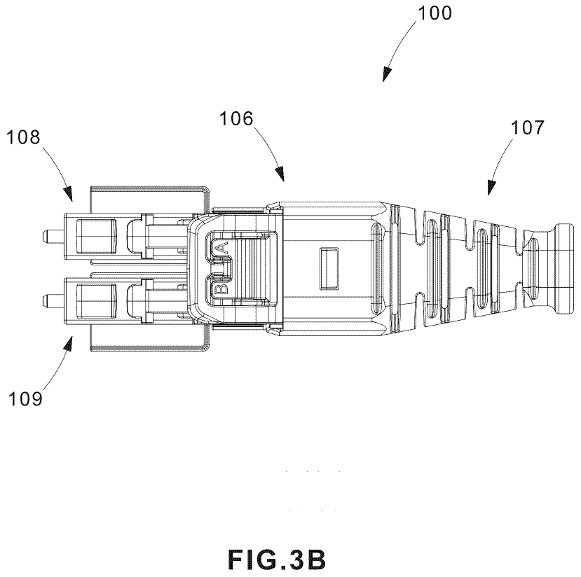

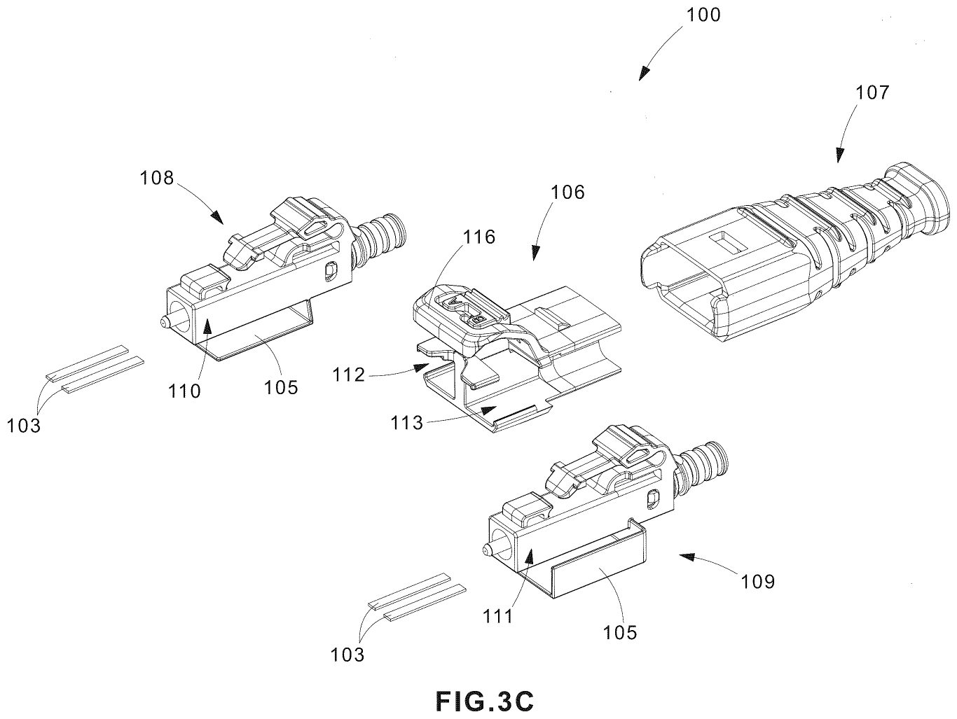

FIG. 3A shows a perspective view of an exemplary LC duplex hybrid connector 100 according to an embodiment of the disclosed solution which is configured for hybrid connections. FIG. 3B shows a top-down view of the LC duplex hybrid connector 100. The main components of the LC duplex hybrid connector 100 include a first LC hybrid connector 108 and a second LC hybrid connector 109, a push-pull clip 106, and a boot 107.

FIG. 3C shows an exploded perspective view of the LC duplex hybrid connector 100 that better shows the main components, as well as showing how each of the first LC hybrid connector 108 and the second LC hybrid connector 109 include their own two conductive plates 103. Each of the two conductive plates 103 are positioned at the base of a housing 110, 111 of their respective first LC hybrid connector 108 and second LC hybrid connector 109. A safety protector 105 made from an insulative material is molded into the housing 110, 111 of the first LC hybrid connector 108 and the second LC hybrid connector 109 to span under and to the sides of the first LC hybrid connector 108 and the second LC hybrid connector 109 so that the conductive plates 103 remained covered. The insulative material, shape, and placement of the safety protector 105 ensures that the conductive plates 103 remain protected (i.e., isolated) from human contact.

The first LC hybrid connector 108 is configured to fit into a first holding area 112 in the push-pull clip 106, and the second LC hybrid connector 109 is configured to fit within a second holding area 113 of the push-pull clip 106 included on the push-pull clip 106. The push-pull clip 106 is configured to fit inside the boot 107.

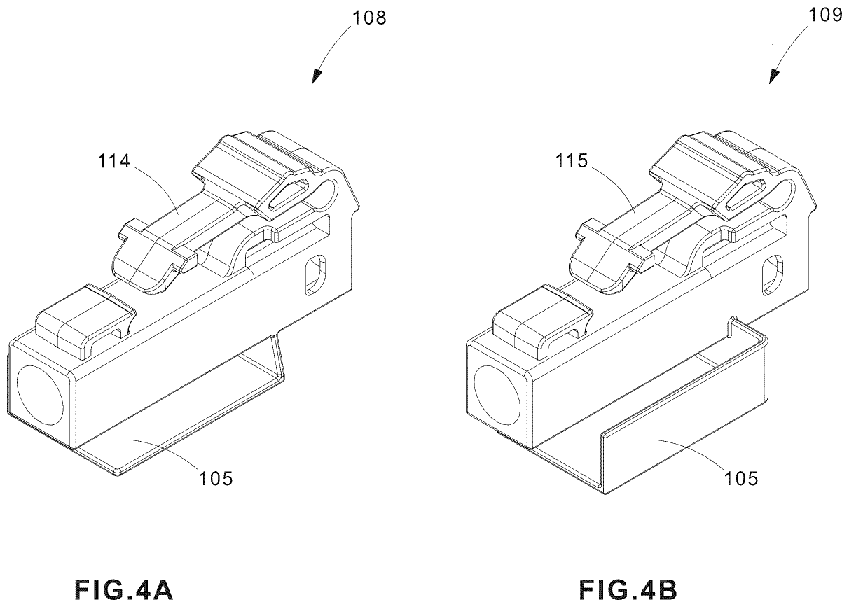

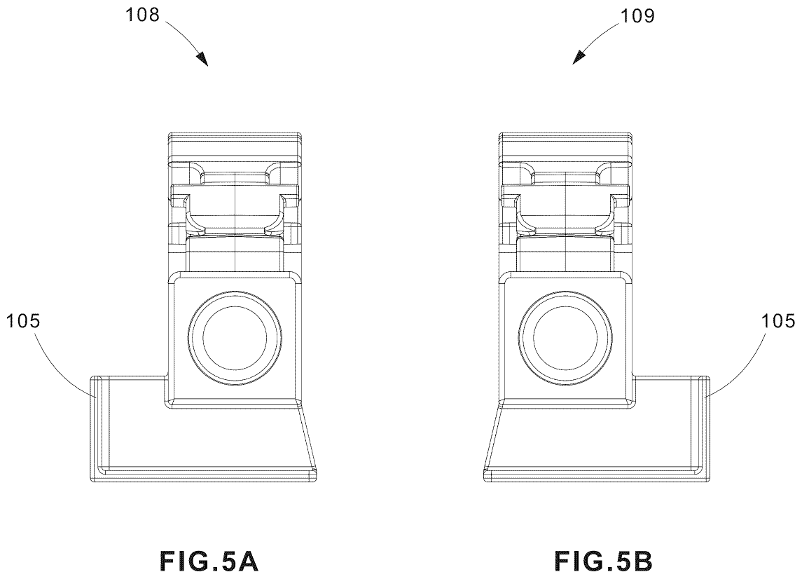

FIG. 4A shows a perspective view of the first LC hybrid connector 108, which shows a latch 114 on a top portion of the housing 110 of the first LC hybrid connector 108. FIG. 4B shows a perspective view of the second LC hybrid connector 109, which shows a latch 115 on a top portion of the housing 111 of the second LC hybrid connector 109. A latch cover 116 in the push-pull clip 106 may cover at least a portion of the latches 114, 115. The safety protector 105 is configured to cover a bottom portion and also extend outward towards an outer end of their respective first LC hybrid connector 108 and second LC hybrid connector 109. This design for the safety protector is shown in the front-side view of the first LC hybrid connector 108 shown in FIG. 5A, and the font-side view of the second LC hybrid connector 109 shown in FIG. 5B.

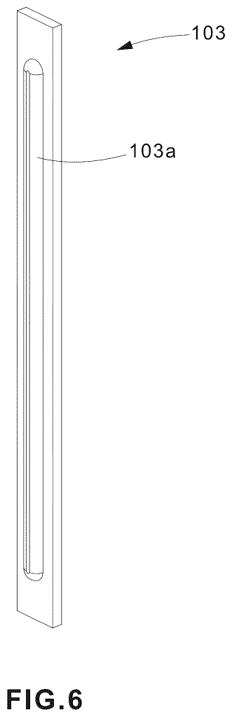

FIG. 6 shows a perspective view of the conductive plate 103 that are included on the bottom portion of the housing 110 for the first LC hybrid connector 108 and the bottom portion of the housing 111 for the second LC hybrid connector 109. As shown, the conductive plate 103 may include a raised portion 103a running down the middle. As described previously, the safety protectors 105 are configured to cover any exposure of the conductive plate 103 on the bottom of the housing in order to, for example, prevent a user from physically touching the conductive plates 103.

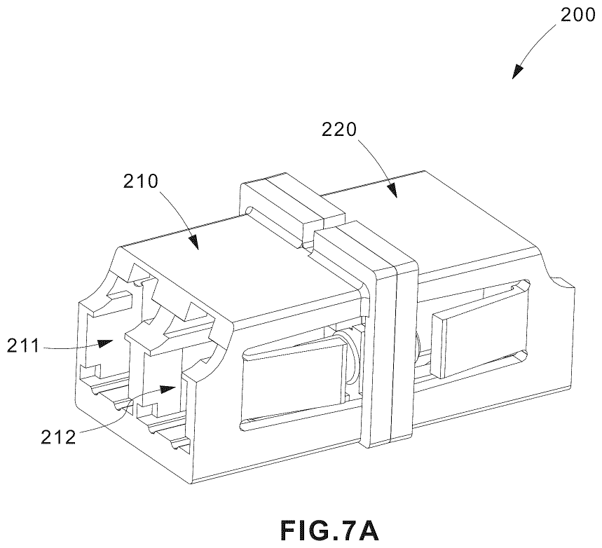

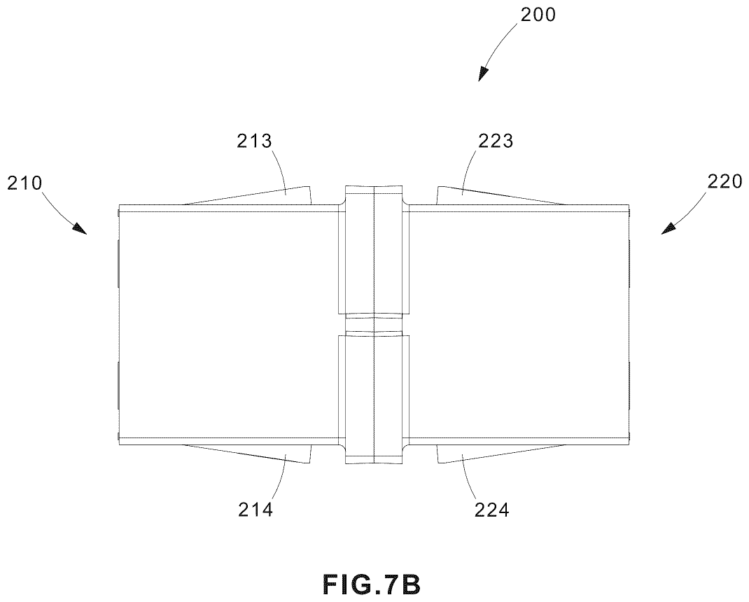

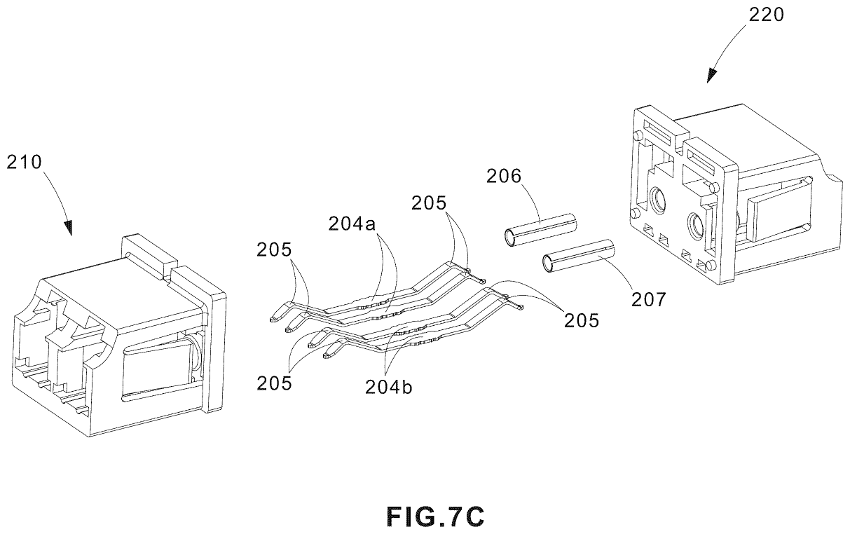

FIG. 7A shows a perspective view of an exemplary LC duplex hybrid adapter 200 according to an embodiment of this disclosure, which is part of the solution described herein. The LC duplex hybrid adapter 200 includes a housing comprising a first half 210 and a second half 220. The first half 210 includes two openings, a first opening 211 and a second opening 212, for inserting the first LC duplex hybrid connector 108, and the second half 220 includes two openings (not shown, but same as the first opening 211 and the second opening 212) for inserting the second LC duplex hybrid connector 109. As shown from the top-down view of the LC duplex hybrid adapter 200 in FIG. 7B, the first half 210 includes a latch 213 on a first side and a latch 214 on an opposite side, for locking in the first half 210 of the adapter 200 on a panel and releasing the first half 210 from the panel when the latch 213, 214 is pressed in. Similarly, the second half 220 includes a latch 223 on a first side and a latch 224 on an opposite side, for locking in the second half 220 of the adapter 200 on a panel and releasing the second half 220 from the panel when the latch 223, 224 is pressed in.

FIG. 7C shows an exploded perspective view of the LC duplex hybrid adapter 200 that shows some internal components. For example, the LC duplex hybrid adapter 200 includes a first pair of conductive leaf springs 204a configured to make contact with a pair of conductive plates 103 positioned at the bottom of an LC hybrid connector installed into the first half 210, as well as make contact with a pair of conductive plates 103 of an LC hybrid connector installed into the second half 220 on the conductive leaf springs 204a at a second end that is inserted into the second half 220. The LC duplex hybrid adapter 200 also includes a second pair of conductive leaf springs 204b configured to make contact with an LC hybrid connector installed into the first half 210 via protrusions 205 on the conductive leaf springs 204b at a first end that is inserted into the first half 210, as well as make contact with an LC hybrid connector installed into the second half 220 via protrusions 205 on the conductive leaf springs 204b at a second end that is inserted into the second half 220. The LC duplex hybrid adapter 200 also includes a first split sleeve 206 for holding the ferrule of a fiber configured to transmit an optical signal from an LC hybrid connector installed into the first half 210 to an LC hybrid connector installed into the second half 220, and vice versa. The LC duplex hybrid adapter 200 also includes a second split sleeve 207 for holding a ferrule of a fiber configured to transmit an optical signal from an LC hybrid connector installed into the first half 210 to an LC hybrid connector installed into the second half 220, and vice versa.

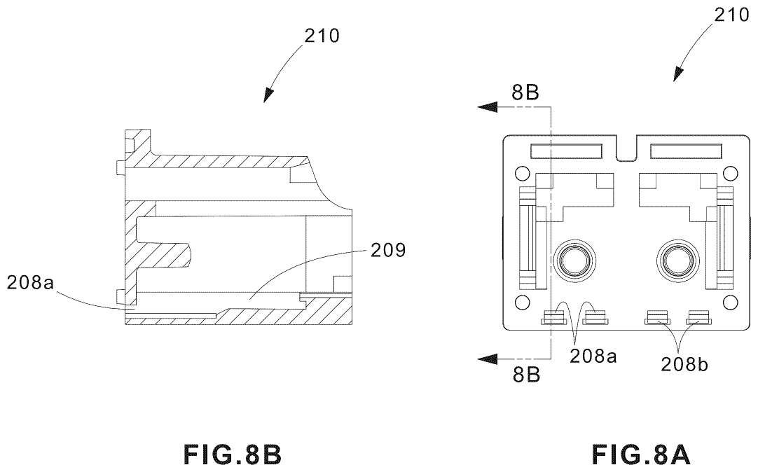

FIG. 8A shows a front-side view of the first half 210, that shows a first pair of slots 208a for housing the first pair of conductive leaf springs 204a, and a second pair of slots 208b for housing the second pair of conductive leaf springs 204b. FIG. 8B shows a cross-sectional view taken along the line 8B-8B from the first half 210 shown in FIG. 8A, where this cross-sectional view shows how the slot 208a provides a housing for holding the conductive leaf spring 204a. An opening 209 at the top of the channel formed by the slot 208a allows the protrusion 205 to pop up to make contact with a conductive plate 103 at the bottom of an LC hybrid connector (e.g., LC hybrid connector 108, 109) that is housed within the first opening 211. It is noted that the second half 220 may mirror the first half 210 in terms of design components and features.

So, these protrusions 205 are configured to push up into their respective openings 209 on the first half 210 and the openings on the second half 220 of the LC duplex hybrid adapter 200. By pushing into these openings 209, the protrusions 205 rise up from the floor of the openings 209 and are positioned to contact the conductive plate 103 on the bottom of the respective LC duplex hybrid connector 108, 109 to allow good contact between the conductive leaf springs 204a, 204b and the conductive plates 103 when the LC duplex hybrid connector 100 is inserted into the LC duplex hybrid adapter 200. It follows that the conductive leaf springs 204a, 204b are configured to transfer electrical power from a conductor wire included in a hybrid cable coupled to the LC duplex hybrid connector 100 inserted into the first half 210 of the LC duplex hybrid adapter 200, to a hybrid cable coupled to the LC duplex hybrid connector 100 inserted into the second half 220 of the LC duplex hybrid adapter 200.

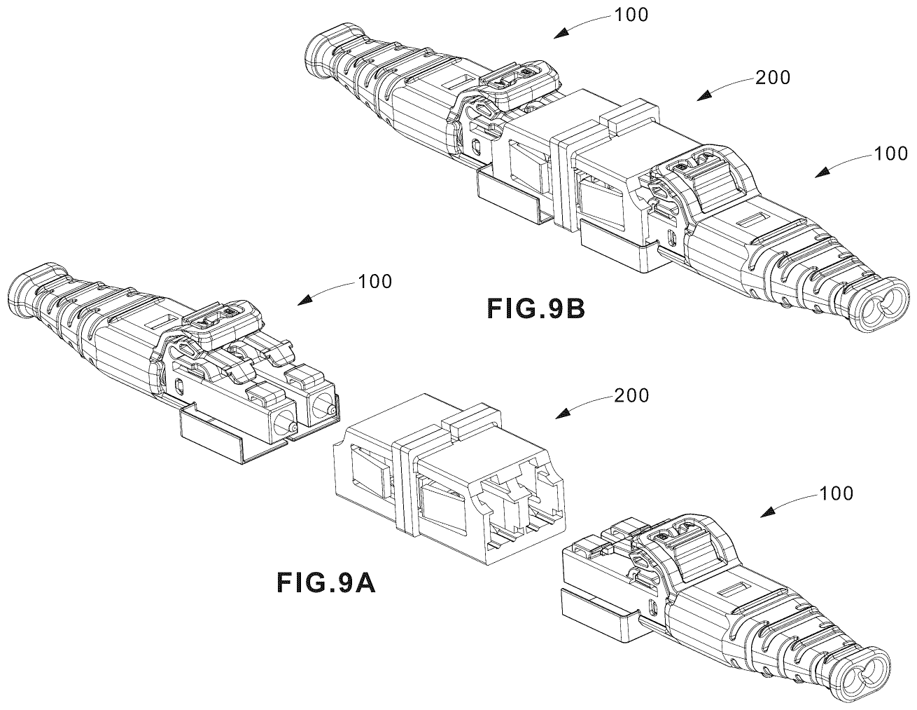

FIG. 9A shows an exemplary embodiment of the LC duplex hybrid connector 100 in a pre-installation state prior to being installed into both sides of the LC duplex hybrid adapter 200. FIG. 9B shows an exemplary embodiment of the LC duplex hybrid connector 100 in an installed state where the LC duplex hybrid connector 100 has been installed into both sides of the LC duplex hybrid adapter 200.

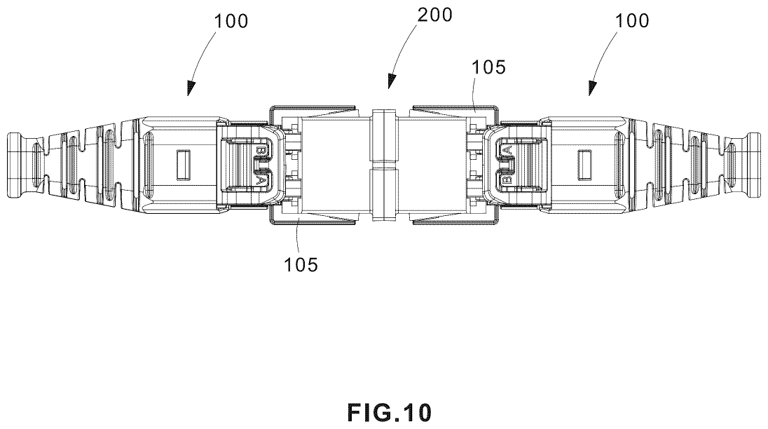

When the LC duplex hybrid connector 100 is inserted into the LC duplex hybrid adapter 200 in the installed state, there is good and sufficient contact made between the conductive plates 103 included in the LC duplex hybrid connectors 100 and the adapter conductive leaf springs 204a, 204b included in the LC duplex hybrid adapter 200, so that electrical power from the LC duplex hybrid connectors 100 installed at the first half 110 of the LC duplex hybrid adapter 200 may be transferred to the LC duplex hybrid connector 100 installed at the other side in the second half 220 of the LC duplex hybrid adapter 200. FIG. 10 is a top-down view of the LC duplex hybrid connector 100 inserted into the LC duplex hybrid adapter 200 in the installed state, where the safety protector 105 can be seen to protrude past event the housing of the LC duplex hybrid adapter 200.

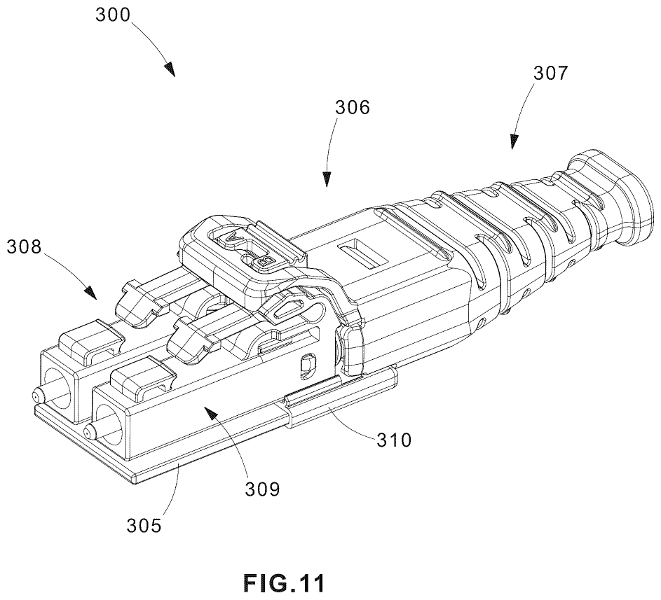

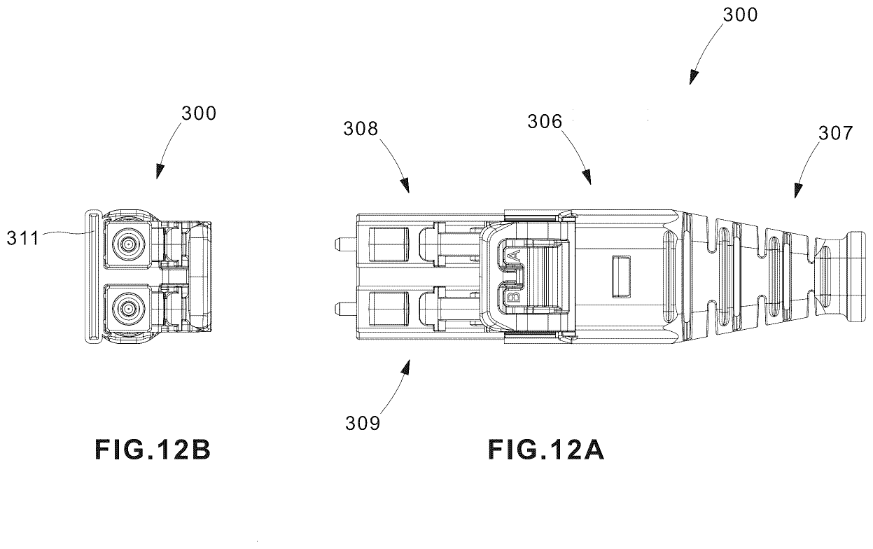

FIG. 11 shows an alternative embodiment of an LC duplex hybrid connector 300. This LC duplex hybrid connector 300 is similar in many aspects to the LC duplex hybrid connector 100 shown in FIG. 3. For example, the LC duplex hybrid connector 300 is configured to include a first LC hybrid connector 308 and a second LC hybrid connector 309, a push-pull clip 306, and a boot 307. One main update to the LC duplex hybrid connector 300 is the design of the safety protector. For example, the push-pull clip 306 includes a slot housing 310 for holding a sliding protector 305. FIG. 12A is a top-down view of the LC duplex hybrid connector 300, where this view shows that the sliding protector 305 offers a slimmer profile (i.e., smaller width) compared to the safety protector 105 included in the LC duplex hybrid connector 100. FIG. 12B is a font-side view of the LC duplex hybrid connector 300 that shows a slot opening 311 to the slot housing 310, where the sliding protector 305 may be inserted through the slot opening 311 to rest inside the slot housing 310. The sliding protector may be made from one of the materials described for the safety protector 105.

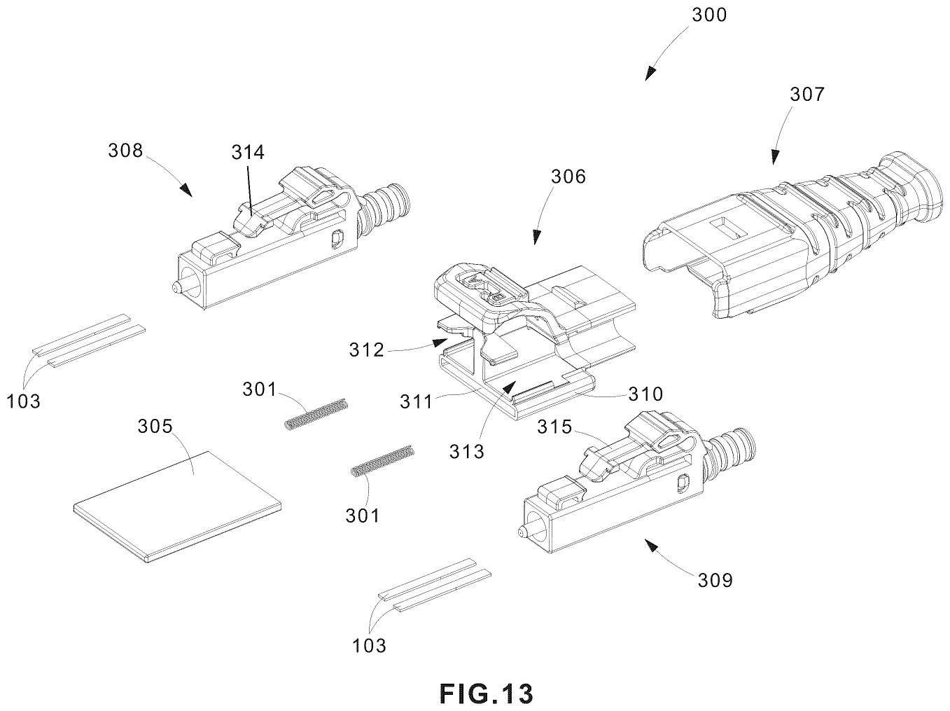

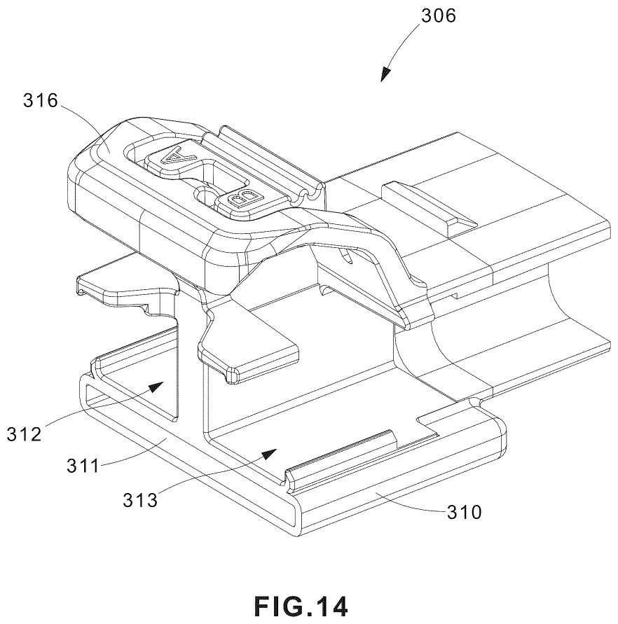

FIG. 13 is an exploded perspective view of the LC duplex hybrid connector 300. FIG. 14 is a perspective view of the push-pull clip 306 alone. From the illustrations of FIG. 13 and FIG. 14, it can be seen that the first LC hybrid connector 308 is configured to fit into a first slot opening 311 of the push-pull clip 306, and the second LC hybrid connector 309 is configured to fit into a second opening 313 of the push-pull clip 306. Also shown are a pair of springs 301, where the sliding protector 305 may be installed within the slot housing 310 via springs 301 installed inside the slot housing 310. When the sliding protector 305 is installed within the slot housing 310, the springs 301 may be in a compressed state so that the springs 301 may also be utilized to provide a spring force for ejecting the sliding protector 305 during a removal process, according to some embodiments. One or more springs 301 may be used according to different embodiments.

Same as the first LC hybrid connector 108, the first LC hybrid connector 308 also includes a pair of conductive plates 103 installed onto a bottom of the housing of the first LC hybrid connector 308. Same as the second LC hybrid connector 109, the second LC hybrid connector 309 also includes a pair of conductive plates 103 installed onto a bottom of the housing of the second LC hybrid connector 309. The first LC hybrid connector 308 also includes a latch 314, and the second LC hybrid connector 309 also includes a latch 315. A latch cover 316 included in the push-pull clip 306 may cover at least a portion of the latches 314, 315.

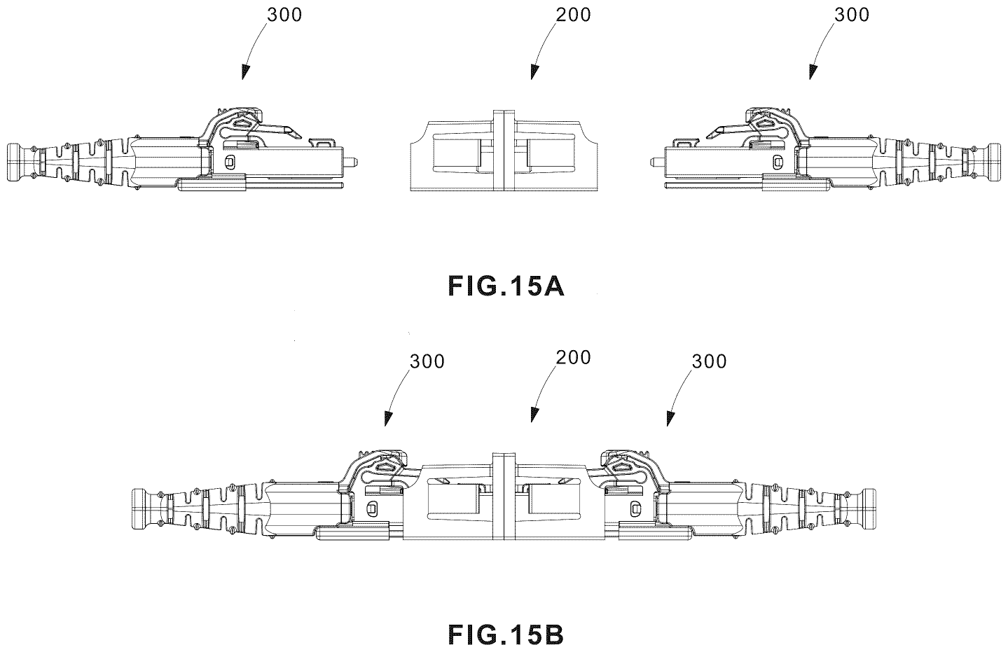

FIG. 15A shows the LC duplex hybrid connector 300 in a pre-installation state prior to being inserted into the LC duplex hybrid adapter 200. In this pre-installation state, the sliding protector 305 is in an extended state due, at least in part, to the spring force from the springs 301 pushing against the sliding protector 305.

FIG. 15B shows the LC duplex hybrid connector 300 in an installed state where the LC duplex hybrid connector 300 has been inserted into both sides of the LC duplex hybrid adapter 200. As the LC duplex connectors 300 are inserted into the LC duplex hybrid adapter 200, the sliding protector 305 will abut against a lower edge of the housing for the LC duplex hybrid adapter 200 so that the sliding protector 305 slides into the slot housing 310, which serves at least two functions. First, by having the sliding protector 305 slid into the slot housing 310, this exposes the portion of the bottom side of the first LC hybrid connector 308 and the second LC hybrid connector where the conductive plates 103 are located so that the conductor plates can make contact with the conductive leaf springs 204a, 204b that are installed within the LC duplex hybrid adapter 200. Second, a portion of the sliding protector 305 will remain extended out from the slot housing 310 to cover access to the conductive plates 103 installed at the bottom of the first LC hybrid connector 308 and the second LC hybrid connector 309, thus providing a safety mechanism that prevents a user from touching the conductive plates 103.

A hybrid fiber and electrical connector and adapter system containing two simplex fiber optic connectors and a corresponding fiber optic adapter is disclosed. The two fiber optic connectors can be connected to each other via the fiber optic adapter, wherein the fiber optic connectors have at least one conductor at the bottom of the connector housing, whereby at least one conductor is aligned to contact the conductor in the fiber optic adapter, wherein the fiber optic adapter has at least one conductor at the bottom of the adapter housing and is aligned to contact at least one conductor of both the fiber optic connectors at each side, wherein a safety protector is attached to the bottom of the connector to protect the user from touching the conductor on the connector.

Also disclosed is the hybrid fiber and electrical connector and adapter system, wherein the conductor at the bottom of the hybrid connector is a flat conductive plate, and the conductor in the hybrid adapter is a conductive leaf spring.

Also disclosed is the hybrid fiber and electrical connector and adapter system, wherein the conductive leaf spring in the hybrid adapter has protrusion toward the conductive plate at the bottom of the hybrid connector to allow good contact and provide a normal force between the conductive leaf spring and the conductive plate so that electrical power from the hybrid connector at one side of the hybrid adapter can be transferred to the hybrid connector at the other side of the hybrid adapter.

Also disclosed is the hybrid fiber and electrical connector and adapter system, wherein the conductor at the bottom of the hybrid connector is a conductive leaf spring, and the conductor in the hybrid adapter is a flat conductive plate.

Also disclosed is the hybrid fiber and electrical connector and adapter system, wherein the conductive leaf spring at the bottom of the hybrid connector has protrusion toward the conductive plate in the hybrid adapter to allow good contact and provide a normal force between the conductive leaf spring and the conductive plate so that electrical power from the hybrid connector at one side of the hybrid adapter can be transferred to the hybrid connector at the other side of the hybrid adapter.

Also disclosed is the hybrid fiber and electrical connector and adapter system, wherein the conductor at the bottom of the connector housing is connected to a conductive sleeve, which can terminate the electrical wire of a field cable by crimping.

Also disclosed is the hybrid fiber and electrical connector and adapter system, wherein the conductor at the bottom of the connector housing is connected to a conductive sleeve which can terminate the electrical wire of a field cable by tightening the screw on the conductive sleeve.

Also disclosed is the hybrid fiber and electrical connector and adapter system, wherein the safety protector is a fixed protector attached to the bottom of the connector, and a gap exists between the protector and the conductor on the hybrid connector to allow it to be inserted into the hybrid adapter.

Also disclosed is the hybrid fiber and electrical connector and adapter system, wherein the safety protector is a sliding protector attached to the bottom of the connector to protect the user from touching the conductor on the connector when the connector is not inserted into the adapter. When the hybrid connector is inserted into the hybrid adapter, the sliding protector is pushed aside by the adapter housing to allow the hybrid connector to be inserted into the hybrid adapter.

Also disclosed is the hybrid fiber and electrical connector, wherein the fiber optic connector features a stub fiber with one pre-polished end at the fiber optic connector's endface. In contrast, the stub fiber's other end can be seamlessly connected to a field fiber to install a fiber optic connector on a fiber optic cable.

Also disclosed is the hybrid fiber and electrical adapter, wherein the hybrid adapter has shutters to prevent the ingress of dust and debris while safeguarding the eyes of workers or technicians involved in the installation or maintenance of a fiber optic system.

Also disclosed is the hybrid fiber and electrical connector and adapter system, wherein the hybrid fiber and electrical connector and adapter system can be installed on a patch panel.

Also disclosed is the hybrid fiber and electrical connector and adapter system, wherein the hybrid fiber and electrical connector and adapter system can be installed in a cassette.

A hybrid fiber and electrical connector and adapter system containing two duplex fiber optic connectors and a duplex fiber optic adapter is disclosed, wherein the two pairs of fiber optic connectors can be connected to each other via the duplex fiber optic adapter, wherein the fiber optic connectors have at least one conductor at the bottom of the connector housing, whereby at least one conductor is aligned to contact the conductor in the fiber optic adapter, wherein the fiber optic adapter has at least one conductor at the bottom of the adapter housing and is aligned to contact at least one conductor of both the fiber optic connectors at each side, wherein a safety protector is attached to the bottom of the connector to protect the user from touching the conductor on the connector.

Also disclosed is the hybrid fiber and electrical connector and adapter system, wherein the conductor at the bottom of the hybrid connector is a flat conductive plate, and the conductor in the hybrid adapter is a conductive leaf spring.

Also disclosed is the hybrid fiber and electrical connector and adapter system, wherein the conductive leaf spring in the hybrid adapter has protrusion toward the conductive plate at the bottom of the hybrid connector to allow good contact and provide a normal force between the conductive leaf spring and the conductive plate so that electrical power from the hybrid connector at one side of the hybrid adapter can be transferred to the hybrid connector at the other side of the hybrid adapter.

Also disclosed is the hybrid fiber and electrical connector and adapter system, wherein the conductor at the bottom of the hybrid connector is a conductive leaf spring, and the conductor in the hybrid adapter is a flat conductive plate.

Also disclosed is the hybrid fiber and electrical connector and adapter system, wherein the conductive leaf spring at the bottom of the hybrid connector has protrusion toward the conductive plate in the hybrid adapter to allow good contact and provide a normal force between the conductive leaf spring and the conductive plate so that electrical power from the hybrid connector at one side of the hybrid adapter can be transferred to the hybrid connector at the other side of the hybrid adapter.

Also disclosed is the hybrid fiber and electrical connector and adapter system, wherein the conductor at the bottom of the connector housing is connected to a conductive sleeve, which can terminate the electrical wire of a field cable by crimping.

Also disclosed is the hybrid fiber and electrical connector and adapter system, wherein the conductor at the bottom of the connector housing is connected to a conductive sleeve which can terminate the electrical wire of a field cable by tightening the screw on the conductive sleeve.

Also disclosed is the hybrid fiber and electrical connector and adapter system, wherein the safety protector is a fixed protector attached to the bottom of the connector, and a gap exists between the protector and the conductor on the hybrid connector to allow it to be inserted into the hybrid adapter.

Also disclosed is the hybrid fiber and electrical connector and adapter system, wherein the safety protector is a sliding protector attached to the bottom of the connector to protect the user from touching the conductor on the connector when the connector is not inserted into the adapter. When the hybrid connector is inserted into the hybrid adapter, the sliding protector is pushed aside by the adapter housing to allow the hybrid connector to be inserted into the hybrid adapter.

Also disclosed is the hybrid fiber and electrical connector, wherein the fiber optic connector features a stub fiber with one pre-polished end at the fiber optic connector's endface. In contrast, the stub fiber's other end can be seamlessly connected to a field fiber to install a fiber optic connector on a fiber optic cable.

Also disclosed is the hybrid fiber and electrical connector and adapter system, wherein the hybrid adapter has shutters to prevent the ingress of dust and debris while safeguarding the eyes of workers or technicians involved in the installation or maintenance of a fiber optic system.

Also disclosed is the hybrid fiber and electrical connector and adapter system, wherein the hybrid fiber and electrical connector and adapter system can be installed on a patch panel.

Also disclosed is the hybrid fiber and electrical connector and adapter system, wherein the hybrid fiber and electrical connector and adapter system can be installed in a cassette.

A hybrid fiber and electrical connector containing at least one fiber optic connector is disclosed, wherein the fiber optic connectors have at least one conductor at the bottom of the connector housing, wherein a safety protector is attached to the bottom of the connector to protect the user from touching the conductor plate on the connector.

Also disclosed is the hybrid fiber and electrical connector, whereby at least one fiber optic connector is a simplex LC, CS, SN, or SC type.

Also disclosed is the hybrid fiber and electrical connector, whereby at least one connector is a multifiber MTP/MPO type.

Also disclosed is the hybrid fiber and electrical adapter containing at least one conductor at the bottom of the adapter housing, whereby the conductor at the bottom of the adapter housing contacts the conductor at the bottom of the connector housing, when the hybrid connector is inserted into the hybrid adapter.

Also disclosed is the hybrid fiber and electrical adapter, whereby the adapter is configured to house at least one fiber optic connector of the simplex LC, CS, SN, or SC type.

Also disclosed is the hybrid fiber and electrical adapter, whereby the adapter is configured to house one multifiber fiber optic MTP/MPO connector type.

The present disclosure thus describes systems, devices, and methods for implementing a hybrid cable connector and adapter assembly system and a method for utilizing the hybrid cable connector and adapter assembly system. As is readily apparent from the foregoing, various non-limiting embodiments of the hybrid cable connector and adapter assembly system, each individual device, and methods for utilizing the hybrid cable connector and adapter have been described. While various embodiments have been illustrated and described herein, they are exemplary only and it is not intended that these embodiments illustrate and describe all those possible. Instead, the words used herein are words of description rather than limitation, and it is understood that various changes may be made to these embodiments without departing from the spirit and scope of the following claims.

What is claimed is:

1. A hybrid cable connector comprising:
a fiber connector comprising a top surface including a latch, a bottom surface, and an internal housing configured to house a fiber component;
a pair of conductive plates attached to the bottom surface of the fiber connector;
an insulative protector configured to cover at least a portion of the bottom surface where the pair of conductive plates are attached.

2. The hybrid cable connector of claim 1, further comprising:
a second fiber connector such that the hybrid cable connector is a duplex connector, the second fiber connector comprising a top surface including a latch, a bottom surface, and an internal housing configured to house a fiber component; and
a second pair of conductive plates attached to the bottom surface of the second fiber connector;
wherein the insulative protector is configured to cover at least a portion of the bottom surface for both the fiber connector and the second fiber connector.

3. The hybrid cable connector of claim 2, wherein the second pair of conductive plates is configured to contact a second pair of leaf springs in a hybrid adapter when the hybrid cable connector is installed in the hybrid adapter.

4. The hybrid cable connector of claim 1, further comprising, a push-pull clip comprising:
a first opening for holding the fiber connector;
a second opening for holding the second fiber connector; and
a slot housing configured to removably hold the insulative protector.

5. The hybrid cable connector of claim 4, the push-pull clip further comprising:
a spring positioned within the slot housing and configured to exert a compression force on the insulative protector.

6. The hybrid cable connector of claim 4, wherein the insulative protector is configured to slide within the slot housing.

7. The hybrid cable connector of claim 4, wherein the insulative protector is molded as part of a housing for the fiber connector.

8. The hybrid cable connector of claim 7, wherein the insulative protector is molded as part of a housing for the fiber connector to cover at least a portion of the bottom surface of the fiber connector and a side of the fiber connector.

9. The hybrid cable connector of claim 1, further comprising:
a boot.

10. The hybrid cable connector of claim 1, wherein the pair of conductive plates is configured to contact a pair of leaf springs included in a hybrid adapter when the hybrid cable connector is installed into the hybrid adapter.

11. A hybrid cable adapter comprising:
a first side housing comprising a first opening for installing a first hybrid connector and a first pair of slot channels;
a second side housing comprising a second opening for installing a second hybrid connector and a second pair of slot channels;
a pair of leaf springs including a first portion configured to be housed within the first pair of slot channels and a second portion configured to be housed within the second pair of slot channels, wherein the first portion is configured to contact a first set of conductive plates attached to the first hybrid connector, and wherein the second portion is configured to contact a second set of conductive plates attached to the second hybrid connector; and
a fiber transmission tunnel configured to transmit an optical fiber from the first hybrid connector installed into the first side housing to the second hybrid connector installed into the second side housing.

12. The hybrid cable adapter of claim 11, wherein the first pair of slot channels are positioned below the opening for installing the first hybrid connector.

13. The hybrid cable adapter of claim 11, wherein the first portion includes a raised portion and the second portion includes a raised portion.
